(19) United States
(12) Patent Application Publication
(10) Pub. No.: US 2004/0247272 A1
(43) Pub. Date: Dec. 9, 2004

(54) Flattened mode cylindrical and ribbon fibers and amplifiers

(75) Inventors: Jay W. Dawson, Livermore, CA (US); Raymond J. Beach, Livermore, CA (US); Stephen A. Payne, Castro Valley, CA (US); Michael D. Feit, Livermore, CA (US); Christopher P.J. Barty, Hayward, CA (US); Zhi M. Liao, Pleasanton, CA (US)

Correspondence Address: Alan H. Thompson, Deputy Laboratory Counsel For Intellectual Prop., Lawrence Livermore National Laboratory, P.O. Box 808, L-703, Livermore, CA, 94551, US

(73) Assignee: The Regents of the University of California

(21) Appl. No.: 10/676,905

(22) Filed: Sep. 30, 2003

Related U.S. Application Data
(60) Provisional application No. 60/475,550, filed on Jun. 3, 2003.

(51) Int. Cl. G02B 6/22

(52) U.S. Cl. 385/127; 385/141

(57) ABSTRACT

Large area mode operation of fibers with Strehl-ratio-optimizing flat-topped output beams is enabled. The approach entails both refractive index profile engineering and gain profile engineering to realize fiber structures that while supporting several transverse modes only allow a preferred flat-topped mode to lase due to the modal gain discrimination that is engineered in during the fabrication of the structure.

This application claims priority to U. S. Provisional Patent Application No. 60/475,550, titled “Flattened Mode Cylindrical And Ribbon Fibers And Amplifiers,” filed Jun. 3, 2003 and incorporated herein by reference.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates to diffraction limited fiber lasers, and more specifically, it relates to fiber lasers characterized by almost constant electric field intensity over the entire core region of the fiber.

2. Description of Related Art

For applications requiring high beam quality radiation from efficient, compact and rugged sources, diffraction limited fiber lasers are ideal, and to date have been demonstrated at average CW power levels exceeding 100 W with near diffraction limited output and a narrow bandwidth light signal. For conventional single-core step-index single-mode fibers, this power level represents the scaling limit because of nonlinear and laser damage considerations. Higher average powers would exceed nonlinear process thresholds such as the Raman and stimulated Brillouin scattering limit, or else damage the fiber due to the high intensity level in the fiber's core. The obvious way to increase the average power capability of fibers is to increase the area of their core [1]. Simply expanding the core dimensions of the fiber allows a straightforward power scaling due to enhanced nonlinear and power handling characteristics that scale directly with the core area. Femtosecond, chirped-pulse, fiber lasers with pulse energies greater than 1 mJ have been demonstrated in the literature [2] using this technique. This output energy was still limited by the onset of stimulated Raman scattering. However, the enhanced power handling capability that obtains through this route comes at the expense of beam quality, as increasing the core diameter in standard step index fibers permits multiple transverse modes to lase simultaneously. Although this problem of multimode operation can be mitigated to some extent by appropriately designing the fiber's waveguide structure, limitations such as bend radius loss, sensitivity to thermally induced perturbations of the waveguide structure, and refractive index control, all become more stringent as the core diameter grows, limiting the extent to which the core diameter can be grown and still enabling single mode operation from the fiber.

The spatial mode character of the radiation supported by the fiber is of concern. Conventional single mode fibers have an electric field that falls of continuously as the radius increases. In the core, the electric field in conventional single mode fibers has a zero-order-Bessel-function-of-the-first-kind radial dependence, and outside the fiber core, a modified-Bessel-function-of-the-second-kind radial dependence. This means that in conventional fibers, the electric field intensity on the fiber axis is higher than in other parts of the core.

### SUMMARY OF THE INVENTION

It is an object of the present invention to provide fiber lasers characterized by almost constant electric field intensity over the entire core region of the fiber

This and other objects will be apparent based on the disclosure herein.

The present invention addresses the limitations described above and enables a new approach to single transverse mode operation of large mode area (LMA) fibers, providing a route to high average powers exceeding 1 kW from a single aperture in a Strehl-ratio-optimizing flat-topped output beam.

The approach described herein is radical in that it eliminates the single-mode fiber on-axis intensity peak through appropriately engineering both the refractive index profile and the gain profile to realize large mode area (LMA) fiber structures that, while supporting several transverse modes, only allow a preferred flat-topped mode to lase. This is due to the modal gain discrimination that is engineered in during the fabrication of the structure. These special flat-topped modes are characterized by almost constant electric field intensity over the entire core region of the fiber.

The present invention has applications in many areas. Some examples are:

Scaled power fiber lasers;

Laser defense applications;

Short pulse laser sources and amplifiers;

Front end pulse generation and amplification system for the National Ignition Facility (NIF) laser system at Lawrence Livermore National Laboratory;

Transport fiber and fiber laser sources for telecommunication applications;

Optical power distribution networks; and

Various materials processing and machining applications, including the following:

Metal cutting;

Metal brazing;

Deep penetration metal welding;

Plastic welding; and

Soldering.

### BRIEF DESCRIPTION OF THE DRAWINGS

FIG. 1A shows the radial refractive index profile of a 50 μm diameter cylindrically symmetric fiber according to an embodiment of the present invention.

FIG. 1B shows the radial gain profile of the fiber of FIG. 1A (0 indicates no gain and 1 indicates gain).

FIG. 2 shows the only allowed m=0 eigenmode of the index modulated structure shown in FIG. 1A. Also indicated is the gain and the index profile (not to scale).

FIG. 3A shows the only allowed m=1 eigenmode of the fiber structure shown in FIG. 1A. Also indicated is the gain profile and the index profile (not to scale).

FIG. 3B shows the only allowed m=2 eigenmode of the fiber structure shown in FIG. 1A.

FIG. 4 shows a one-dimensional flattened-mode structure that can be constructed from soft glasses and is compatible with refractive index control at the level of 1×10⁻³.

FIG. 5 shows that the one-dimensional waveguide structure of FIG. 4 supports the flat-topped mode shown here. Also indicated is the gain profile and the index profile (but not to scale).

FIG. 6 shows the calculated overlap of the eigenmodes of the one-dimensional waveguide shown in FIG. 4 with the gain-loaded portion of the waveguide, as a function of the eigenmodes' effective index value.

FIG. 7 is an end on view of a ribbon fiber containing elevated index tabs in the strips located at the top and bottom of the waveguide region. These tabs enable the vertical transverse dimension of the waveguide to be increased while still ensuring flat-topped mode operation in that dimension as detailed above.

FIG. 8A shows the refractive index profile and preferred mode of a cylindrically symmetric LFM fiber.

FIG. 8B shows a comparison of the intensity profiles of a step index fiber and a cylindrically symmetric LFM fiber with the same total power.

FIG. 9A shows output energy vs. pump diode current for the step index control fiber and the LFM fiber.

FIG. 9B shows Raman peak spectral power as a function of the pump diode current for the same fibers.

FIG. 10 shows an embodiment of the present invention.

### DETAILED DESCRIPTION OF THE INVENTION

The present invention reduces the intensity of light propagating in the core by distributing it more evenly across the core area via careful design of the refractive index profile [3]. The primary issue that results from scaling the core is addressed. The enhanced power handling capability comes at the expense of beam quality, as increasing the core diameter in standard step index fibers permits multiple transverse modes to lase simultaneously. Although this problem of multimode operation can be mitigated to some extent by appropriately designing the fiber's waveguide structure, limitations such as bend radius loss, sensitivity to thermally induced perturbations of the waveguide structure, and refractive index control, all become more stringent as the core diameter grows, limiting the extent to which the core diameter can be grown and still ensure single mode operation from the fiber. The large flattened mode fiber of the present invention addresses some of these limitations and enables a new approach to single transverse mode operation of large mode area (LMA) fibers, providing a route to high average powers exceeding 1 kW from a single aperture in a Strehl-ratio-optimizing flat-topped output beam.

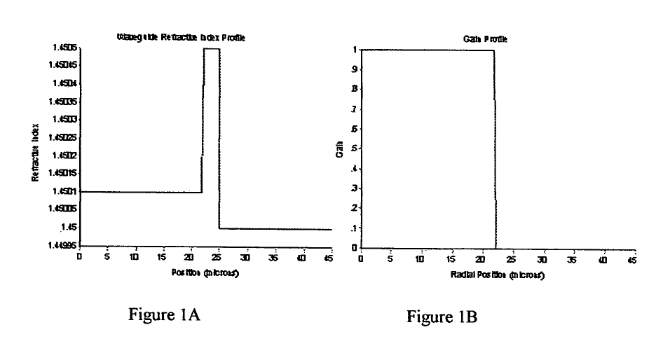

There are two degrees of freedom in the way modal gain discrimination can be managed in cylindrically symmetric fibers. Both the refractive index profile and the gain profile can be modulated radially to first promote specific modal fields, and then to favor some subset of the total supported mode spectrum of the structure. As an example, FIG. 1A shows a specific refractive index profile and FIG. 1B shows a gain profile that together support a flattened-mode. A very low numerical aperture (NA) structure is utilized to limit the total number of modes that are guided by the fiber.

The particular design shown in FIGS. 1A and 1B corresponds to a 50 μm diameter fiber core and uses refractive index values that are conveniently accessible in fused silica. The gain is confined to an interior region having a radial extent of 22.2 μm, leaving a 2.8 μm wide outer undoped annular ring with a refractive index elevated from the outer cladding by 5×10⁻⁴. The specific choice of the index structure shown in FIG. 1A limits the total number of supported transverse modes to only three, and as will be shown, one of these has the desired flat-topped irradiance profile. The gain profile shown in FIG. 1B is then designed to strongly favor this preferred flat-topped mode over the other supported modes. Importantly, the fiber design in FIG. 1A uses index step variations of 1×10⁻⁴, which are within the control limits of today's fused silica based fiber preforms from which fibers are pulled.

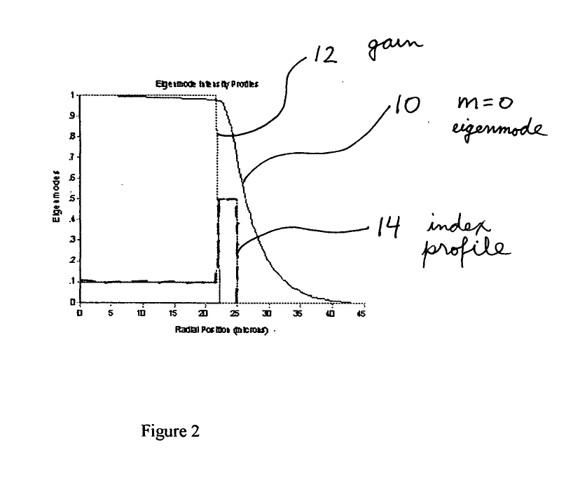

FIG. 2 shows the only allowed m=0 eigenmode 10, where m refers to the azimuthal quantum number of the eigenmode (e^{imφ}), of the optical structure shown in FIG. 1A. Also indicated at 12 is the gain and at 14 the index profile (not to scale).

The elevated index in the annular ring between 22.8 μm and 25 μm is present to ensure the mode shown in FIG. 2 is confined. Additionally, the width and height of this elevated index ring is chosen to engineer the confined mode in FIG. 2 so as to have a nearly flat irradiance profile within the central portion of the fiber. Because a flat-topped profile is the aperture distribution that gives the highest Strehl ratio, this feature of the present fiber design is very important for any application requiring optimized on-axis laser intensity in the far field. Additionally, the flat-topped mode benefits damage considerations, as there are no local regions having peaked irradiance. The effective mean field diameter of the m=0 mode in FIG. 2 is 54 μm and was chosen to maintain robust single mode behavior in the presence of the thermal gradients that will be set up in the actively pumped structure. This design consideration will be discussed in more detail below.

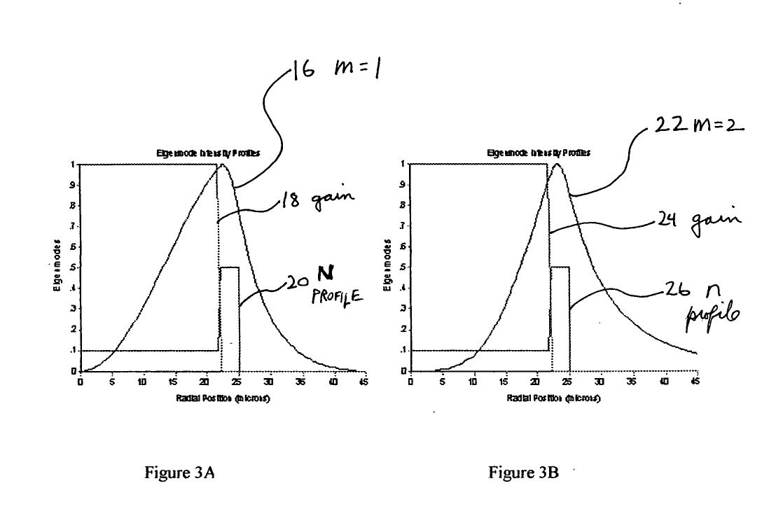

The gain experienced by different laser modes is proportional to the overlap factor, Γ, of the mode's intensity envelope with the gain-loaded portion of the fiber,

$$Γ = \frac{\int {\vert E ( r , θ ) \vert}^{2} g ( r ) rdr ⅆ θ}{\int {\vert E ( r , θ ) \vert}^{2} rdr ⅆ θ} \qquad ( 1 )$$

where g(r) is a function with value unity in those portions of the fiber that are gain loaded and 0 where there is no gain loadingand where E(r, θ) is the electric field of the mode in for with the gain overlap is being calculated expressed in a cylindrical co-ordinate system across the cross section of the fiber and r and θ are the usual radial and azimuthal coordinates common in a cylindrical co-ordinate system. This is a straightforward calculation once the eigenmode fields are known. In addition to the m=0 eigenmode shown in FIG. 2, the optical structure shown in FIG. 1A also supports a single m=1 eigenmode 16 and a single m=2 eigenmode 22, which are shown respectively in FIGS. 3A and 3B. FIG. 3A also shows gain 18 and index profile 20. FIG. 3B also shows gain 24 and index profile 26.

The eigenmodes depicted in FIGS. 2, 3A and 3B are the only allowed eigenmodes supported by the optical structure in FIG. 1A. The eigenmode shown if FIG. 2 fills the aperture and is nearly flat-topped in profile, which means it will have a high Strehl ratio, and for this reason is the desired mode to favor in the operation of the device. Locating the gain along the center of the fiber, coinciding with the index well there, as shown in FIG. 1A, gives a gain discrimination between the allowed modes that favors the flat-topped mode; the overlap of the flat-topped mode shown in FIG. 2 is 0.79, while that of the modes shown in FIG. 3A is only 0.58 for the m=1 mode and in FIG. 3B is only 0.33 for the m=2 mode.

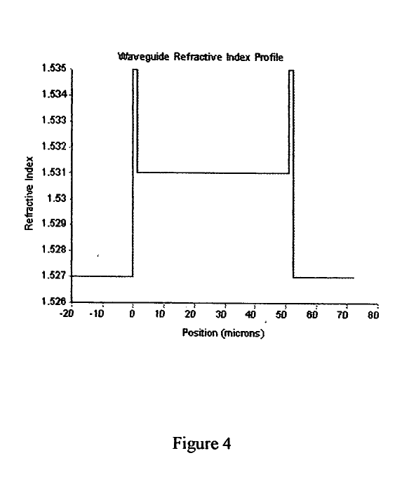

The same design rationale that went into engineering a cylindrical index profile to ensure it supported a flat-topped mode can also be applied to ribbon structures in the transverse dimension perpendicular to the ribbon-guiding dimension. An example of such a flat-topped enabling one transverse dimension index structure is shown in FIG. 4.

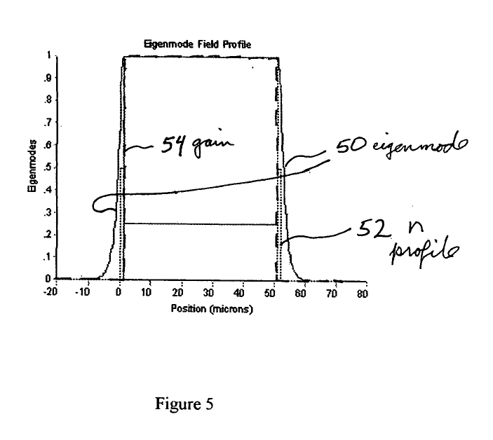

The connection with the two-dimensional cylindrically symmetric fiber shown in FIG. 1 is evident The elevated index tabs at the edge of the waveguide region are engineered in their height and width to specifically support the flat-topped mode that is depicted in FIG. 5. FIG. 5 shows the eigenmode 50, the index profile 52, and the gain 54.

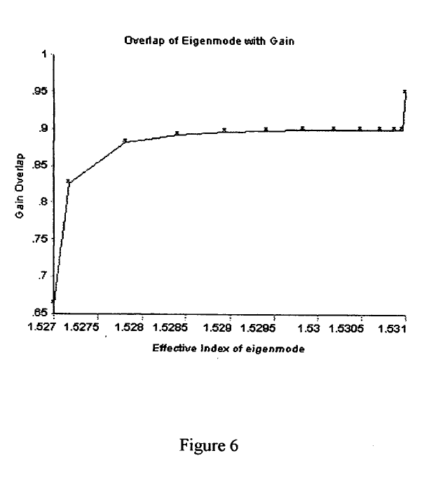

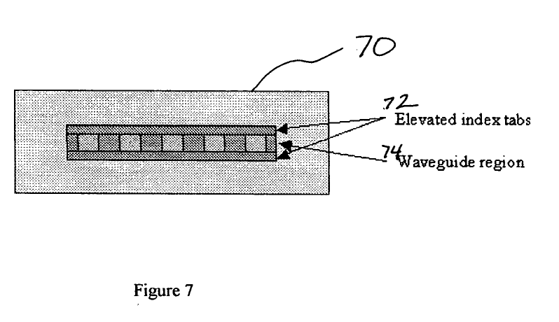

The graph in FIG. 6 plots the calculated overlap of the eigenmodes supported by the one-dimensional waveguide structure of FIG. 4, the gain-loaded portion of the waveguide, the Γ factor given by equation 1 above, as a function of the eigenmodes' effective index value. This is a straightforward calculation once the eigenmode fields are known. The effective index values, n_{eff}, associated with the various eigenmodes of the structure is defined by,

$$β = \frac{{n}_{eff} ω}{c} , \qquad ( 2 )$$

where β is the longitudinal wavevector associated with the eigenmode, ω is the radial frequency of the light propagating in the fiber core and c is the speed of light in vacuum. From equation 2 above it is seen that c/n_{eff} is just the phase velocity associated with the eigenmode as it propagates in the ribbon structure. The two parameters, n_{eff} and Γ, completely define an eigenmode in terms of its wave-optics propagation and energetics behavior. The spectrum of values of n_{eff} and Γ for a given structure completely defines its modal properties, which can be conveniently summarized in a plot such as FIG. 6. Examining FIG. 6, the highest effective index eigenmode, which corresponds to the flat-topped mode plotted in FIG. 5, is also the mode with the highest gain overlap. The larger number of eigenmodes supported by the one-dimensional structure of FIG. 4 compared to the cylindrically symmetric fiber structure of FIG. 1 is a result of the larger Δn (index variations) used in its design. Even so, the highest gain mode in FIG. 6 has an overlap with the gain region that is discriminated by 5% from the next highest gain mode, a level that should be sufficient to measure experimentally. FIG. 7 illustrates how this approach is applicable to the thin dimension of a ribbon fiber 70, and shows elevated index tabs 72 and waveguide region 74.

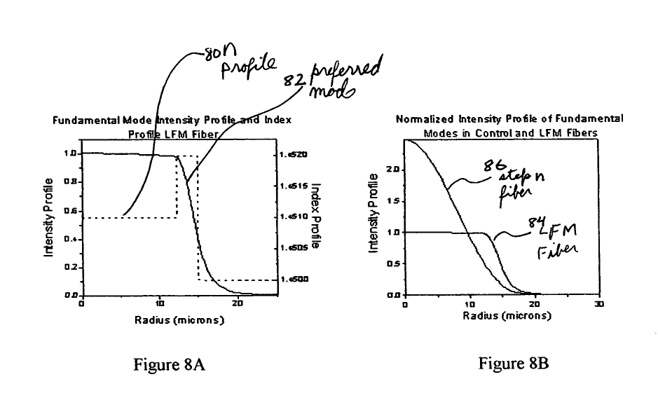

FIG. 8A shows experimentally obtained refractive index profile 80 for the flat-topped fiber mode 82. FIG. 8B shows the intensity distribution of a large flattened mode fiber design (LFM) 84 and a control standard step index profile fiber 86 of the same core diameter normalized such that the total power contained in the two modes is the same. (i.e., The two intensity distributions contain the same total power after the integration over the full cross sectional area is performed.) The LFM design decreases the peak intensity on axis by a factor of 2.46, which should lead to a significant decrease in the amount of stimulated Raman scattering for a given pulse energy, while not compromising the power handling capability.

In one test, the inventors purchased a 30 μm core, 0.06 NA, step-index, control fiber (Nufern) with a 400 μm hexagonal cladding with a low index polymer coating (pump clad NA=0.37). The core was doped with Yb³⁺ such that there was an effective core absorption of 120 dB/m at 977 nm. Also purchased was a nearly identical fiber from Nufern, but with the raised ring that gives the LFM fiber its distinctive index profile. The inner core diameter of the LFM was 25.3 μm and the outer core diameter was about 30 μm FWIIM, the effective NA of the structure was approximately 0.06. The outer cladding and Yb³⁺ doping were the same as for the control fiber.

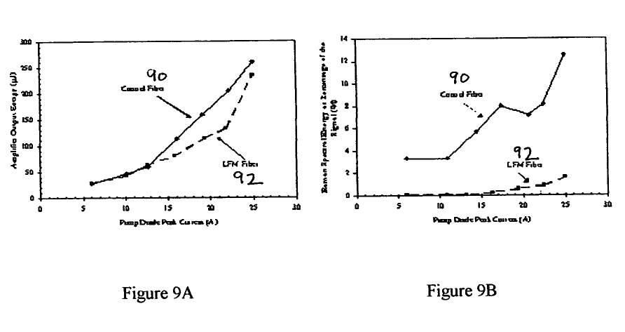

The present inventors then coupled 1.2 ns, 1075 nm, 10 Hz stretched mode-locked laser pulses into 9.1 m of the control fiber and 8.3 m of the LFM fiber. The input energy coupled into the fiber cores was 15 μJ. Pump light at 977 nm from a 10W diode laser array was counter propagated through the fiber to pump the Yb³⁺ ions. The diode light was pulsed at 10 Hz for 1 ms timed to precede the arrival of the signal light FIG. 9A shows the amplified output energy of the control fiber 90 and the LFM fiber 92 as measured with a Molectron energy meter. As expected, they produce roughly the same output energy as a function of pump diode current FIG. 9B, however, plots the percentage of the signal power contained in the first stokes spectra of the fibers of FIG. 9A as measured with an Ocean Optics fiber coupled spectrometer. The LFM fiber shows significantly less Raman energy build up as a function of diode current than the control fiber. This is in agreement with what was expected from the design. In addition, greater than 0.6 mJ output pulses were achieved from the LFM amplifier with less than 5% of the energy in the Raman spectral band by utilizing pulses stretched to 3 ns. With straightforward scaling of Yb³⁺ doping concentration to reduce the amplifier length, increasing the core size to 50 μm and increasing the pump energy, an optimized design could yield output pulses with greater than 10 mJ of energy and virtually no degradation due to stimulated Raman scattering.

For present invention fibers with similar core sizes, doping concentrations and lengths, the present inventors have shown a significant decrease in the amount of Raman scattering in the LFM fiber over a standard step-index fiber. The inventors believe these fibers can be scaled to output energy in excess of 10 mJ in a straightforward fashion as shown in the table below.

| Pulse | Pulse | Core | Fiber | Fiber | |
|---|---|---|---|---|---|
| energy | length | size | length | gain | |
| (mJ) | (ns) | (μm) | (m) | (dB) | Comments |
| 1.2 | 0.4 | 50 | 2.6 | 26 | Galvanauskas, et al. [1] |
| 0.6 | 3 | 30 | 8.3 | 8 | LFM result from this report |
| | | | | | Higher gains yield increase |
| | | | | | output energy before the |
| | | | | | onset of Raman scattering. |
| | | | | | Our result was hurt by low |
| | | | | | gain. |
| 9 | 3 | 50 | 2.6 | 26 | Estimated (assumes one |
| | | | | | overcomes Raman scatter- |
| | | | | | ing using Galvanauskas |
| | | | | | system and increasing |
| | | | | | pulse stretch to 3 ns) |
| 21.6 | 3 | 50 | 2.6 | 26 | Estimated from above base |
| | | | | | on using LFM design to |
| | | | | | further increase the Raman |
| | | | | | scattering threshold |

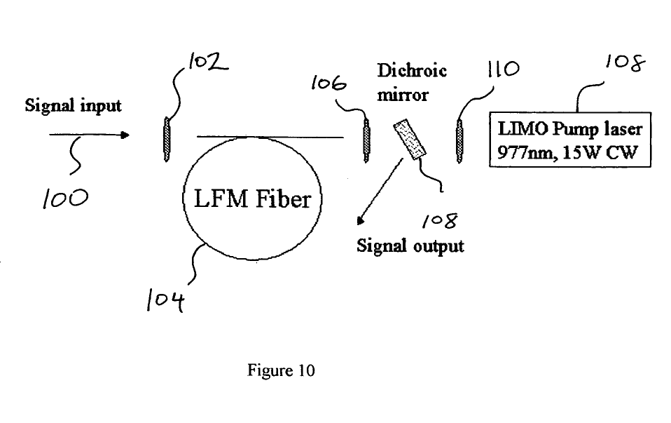

In a high power optical fiber amplifier embodiment, the invention can be used to amplify either pulsed laser light or laser light that more closely approximates a continuous wave laser signal. A schematic of the amplifier is shown in FIG. 10.

An embodiment of the optical fiber amplifier shown in FIG. 10 consists of a signal input 100 consisting of a 1053 nm light source, which may consist either of chirped pulses from a 1053 nm mode-locked laser or continuous wave light from, e.g., a 1053 nm DFB laser. The signal light is focused through the first focusing lens 102, whose focal length is chosen to optimize the coupling of the signal light to the large flattened mode of the LFM fiber waveguide 104 core. The LFM fiber 104 consists of a core with the waveguide and gain profiles shown in FIGS. 1A and 1B, which support a large flattened mode at 1053 nm. The raise ring shown in FIG. 1A is fused silica doped with a standard co-dopant (for raising the index of the fiber such) as germania, phosphorous or alumina. The center region is fused silica doped with Yb³⁺, co-doped with aluminum and other dopants as needed to adjust the refractive index appropriately. The Yb³⁺ concentration is such that 976 nm light propagating in the waveguide experiences a small signal absorption of greater than 120 dB/m. The fused silica outer cladding is hexagonal in shape with 400 μm between flats of the hexagon. Polymer outer coating on the fiber is a low index fluorinated acrylate creating a multimode pump light waveguide in the 400 mm cladding with an numerical aperture greater than 0.35. The fiber is 10 m long and wound around a cylindrical mandrel with a radius of about 4 cm, which is chosen such that signal light propagating in the large flattened mode experiences minimal bend induced attenuation, but signal light propagating in the higher order waveguide modes experiences significant bend induced attenuation. Variations in the manufacture of the fiber against the preferred ideal may alter this preferred radius, which may need to be determined experimentally for each lot of optical fiber. The particular fiber used in this reduction to practice was manufactured by Nufern to custom specifications. In order to suppress undesirable back reflections from the fiber endfaces into the amplifier, these end faces are preferentially angle cleaved or polished in a plane whose normal is 8 degrees off the cylindrical axis of the fiber. The signal light is amplified in the fiber and exits the opposite end, where it is collimated by a second lens 106 and reflected from a dichroic mirror 108 that has a high reflectivity at 1053 nm and high transmission at 976 nm. A high power pump diode 108, such as a 976 nm LIMO 25 W fiber coupled laser diode with a spot size of 400 mm and an NA of 0.22, is imaged through a lens 110, traverses the dichoric mirror and is imaged through the output collimation lens for the signal into the pump dadding of the fiber. Light from the pump laser is absorbed by the Yb³⁺ ions and provides the energy for the amplification of the signal light

One skilled in the art can see that there are many variations on this amplifier that can easily be made without changing the basic design. These include varying the rare earth ion, pump laser and signal wavelength to achieve an amplifier in other wavelength bands. These also indude deliberately providing feedback to the amplifier in place of a signal input in order to create a laser oscillator said feedback may be Q-switched or employ a saturable absorber to generate pulsed laser light as well as continuous wave laser oscillation. Such a laser could be frequency doubled or frequency mixed with a second similar laser to achieve a source of light at shorter wavelengths. This shorter wavelength light source could then be used as a pump laser source for other lasers or for optical parametric oscillators or amplifiers.

Further, an integrated chirped pulse amplifier could be made based on FIG. 10 by adding a pulse stretcher at the signal input One skilled in the art can also recognize that the optical amplifier may be altered to include a second pump laser at the fiber input, to be pumped only at the fiber input, may include one or more optical isolators to prevent feedback into the amplifier from optical components in other parts of a bigger system, etc.

References:

1. M. E. Fermann, “Single-mode excitation of multimode fibers with ultrashort pulses”, Optics Letters, vol. 23, pp. 52, (1998).

2. A. Galvanauskas, Z. Sartania, M. Bischoff, “Millijoule femtosecond all-fiber system”, CLEO 2001, Baltimore, Md., paper CMA1.

3. A. K. Ghatak, I. C. Goyal, R Jindal, “Design of waveguide refractive index profile to obtain flat modal field” SPIE Proceedings vol. 3666, pp. 40 (1998).

The above references are incorporated by reference.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising an optical fiber having at least three distinct, concentric cylindrical regions 1, 2 and 3 having corresponding refractive indices of n₁, n₂ and n₃ and corresponding diameters d₁, d₂ and d₃, where n₂>n₁>n₃ and d₃>d₂>d₁ and at least one of these regions contains an optically active rare earth ion.

2. The apparatus of claim 1, further comprising means for optically pumping said optical fiber, said apparatus further comprising means for coupling signal light into said optical fiber to be amplified.

3. The apparatus of claim 2, wherein said means for optically pumping said optical fiber includes a laser diode or laser diode array.

4. The apparatus of claim 2, wherein n₁, n₂ and n₃ and d₁, d₂ and d₃ are chosen to provide a fundamental optical mode at the wavelength of said signal light such that the electric field of said fundamental optical mode at the center of said cylindrical regions is approximately the same strength as the electric field at the outer edge of region 2.

5. The apparatus of claim 1, wherein said optical fiber is further surrounded by a region with refractive index n₄<n₃ to provide a multi-mode waveguide.

6. The apparatus of claim 1, wherein the cylindrical symmetry of region 3 is deliberately broken via de-centering of region 3 from regions 1 and 2 or by altering the outside shape of region 3.

7. The apparatus of claims 1, wherein the optically active rare earth ion is selected from one of the following Yb³⁺, Nd³⁺, Sm³⁺, Tm³⁺, Er³⁺, Ho³⁺, Dy³⁺ or Pr³⁺.

8. The apparatus of claim 1, wherein said optical fiber comprises fused silica in region 3 and fused silica with germinia, phosphorous, fluorine or alumina in regions 1 and 2.

9. The apparatus of claim 1, wherein n₃ is nominally the index of fused silica, n₂=n₃+0.002 and n₁=n₃+0.001 and d₁=24.4 μm, d₂=30 μm and d₃ is in the range of 80 to 1000 μm.

10. The apparatus of claim 1, wherein n₃ is nominally the index of fused silica, n₂=n₃+0.002 and n₁=n₃+0.001 and d₁=44.72 μm, d₂=50 μm and d₃ is in the range of 80 to 1000 μm.

11. The apparatus of claim 1, wherein said rare earth ion is confined to region 1 or a concentrically located subregion of region 1.

12. The apparatus of claims 1, wherein said fiber is preferentially wound around a cylindrical mandrel of radius R, where R is chosen such that there is minimal bend induced attenuation for the desired waveguide mode propagating in the core of the fiber, but significant attenuation for all other modes at the signal wavelength.

13. The apparatus of claim 1, wherein said signal pulse comprises an ultrashort pulse, said apparatus further comprising means for temporally stretching said signal pulse prior to coupling said signal light into said optical fiber, wherein the stretched pulse is greater than 10 times longer in time than said signal pulse.

14. The apparatus of claim 2, further comprising means for providing feedback to said apparatus.

15. The apparatus of claim 14, wherein means for providing feedback include at least one mirror configured to reflect a portion of light emitted optical fiber back into said optical fiber.

16. The apparatus of claim 14, wherein said means for providing feedback includes at least one optical isolator.

17. The apparatus of claim 2, further comprising a Q-switch operatively positioned to produce a pulsed output from said optical fiber.

18. The apparatus of claim 2, further comprising polarizers and polarization control elements operatively positioned to achieve mode-locking, the apparatus further comprising a parallel grating pair operatively balance cavity dispersion.

19. The apparatus of claim 2, further comprising a non-linear crystal provided at the laser output in order to frequency double the laser output.

20. The apparatus claim 2, further comprising a non-linear crystal configured for sum frequency generation.

21. A method, comprising:
providing an optical fiber having at least three distinct, concentric cylindrical regions 1, 2 and 3 having corresponding refractive indices of n₁, n₂ and n₃ and corresponding diameters d₁, d₂ and d₃, where n₂>n₁>n₃ and d₃>d₂>d₁ and at least one of these regions contains an optically active rare earth ion;
optically pumping said optical fiber; and
coupling signal light into said optical fiber to be amplified.

22. The method of claim 21, wherein the step for optically pumping said optical fiber includes optically pumping with a laser diode or laser diode array.

23. The method of claim 21, wherein n₁, n₂ and n₃ and d₁, d₂ and d₃ are chosen to provide a fundamental optical mode at the wavelength of said signal light such that the electric field of said fundamental optical mode at the center of said cylindrical regions is approximately the same strength as the electric field at the outer edge of region 2.

24. The method of claim 21, wherein said optical fiber is further surrounded by a region with refractive index n₄<n₃ to provide a multi-mode waveguide.

25. The method of claim 21, wherein the cylindrical symmetry of region 3 is deliberately broken via de-centering of region 3 from regions 1 and 2 or by altering the outside shape of region 3.

26. The method of claims 21, wherein the optically active rare earth ion is selected from one of the following Yb³⁺, Nd³⁺¹, Sm³⁺, Tm³⁺, Er³⁺, Ho³⁺, Dy³⁺ or Pr³⁺.

27. The method of claim 21, wherein said optical fiber comprises fused silica in region 3 and fused silica with germinia, phosphorous, fluorine or alumina in regions 1 and 2.

28. The method of claims 21, wherein said fiber is preferentially wound around a cylindrical mandrel of radius R, where R is chosen such that there is minimal bend induced attenuation for the desired waveguide mode propagating in the core of the fiber, but significant attenuation for all other modes at the signal wavelength.
